(19) United States
(12) Patent Application Publication
(10) Pub. No.: US 2026/0018708 A1
(43) Pub. Date: Jan. 15, 2026

(54) CELL SEPARATING ELEMENT WITH FIRE PROTECTION LAYER AND BATTERY MODULE

(71) Applicant: AUDI AG, lngolstadt (DE)

(72) Inventors: Michael ERNST, Wüstenrot (DE); Jürgen GERBRAND, Kirchberg an der Murr (DE); Jürgen STEGMAIER, Kirchberg (DE); Arjan STRATING, Weinsberg (DE)

(73) Assignee: AUDI AG, lngolstadt (DE)

(21) Appl. No.: 19/256,354

(22) Filed: Jul. 1, 2025

(30) Foreign Application Priority Data
Jul. 10, 2024 (DE) 102024119611.4

(51) Int. Cl. H01M 10/658

(52) U.S. Cl. CPC H01M 10/658; H01M 2220/20

(57) ABSTRACT

A cell separating element for arrangement between two battery cells of a cell stack, the cell separating element is elastically compressible at least in a first direction and includes at least one fire protection layer. The cell separating element includes a flexible outer shell enclosing an interior space in which a fluid is located, the at least one fire protection layer is arranged in the interior space and comprises an intumescent material.

### FIELD

The invention relates to a cell separating element for arrangement between two battery cells of a cell stack, wherein the cell separating element is elastically compressible at least in a first direction and comprises at least one fire protection layer. Furthermore, the invention also relates to a battery module.

### BACKGROUND

A battery module, for example for a motor vehicle battery, in particular a high-voltage battery, can comprise a plurality of battery cells arranged next to one another in a stacking direction. Cell separating elements can be arranged between such battery cells, which cell separating elements can perform a wide variety of tasks. Ideally, these should allow the battery cells to swell to a certain extent, which is also known as battery cell swelling. Elastically compressible properties are advantageous for this purpose. On the other hand, the best possible insulation and/or fire protection between the cells would also be desirable in order to offer the best possible protection to neighboring cells in the event of a thermal runaway of a battery cell and to prevent the spread of thermal propagation as far as possible. However, it has not yet been possible to satisfactorily integrate these properties into a cell separating element.

DE 10 2020 007 327 A1 describes a multi-layer protective element for thermal and/or electrical insulation and/or fire protection of a battery. The protective element is intended to be used in the interior of a battery.

DE 10 2019 130 436 A1 describes an energy storage device with a fabric mat comprising a plurality of fibers coated with a flame-retardant layer. The energy storage cells should be covered by the fabric mat.

Furthermore, WO 2017/139826 A1 describes a battery with battery cells, wherein at least two adjacent battery cells can be thermally insulated at a predetermined temperature by a preferably intumescent protective material.

DE 10 2022 104 370 A1 describes a battery cell unit with a battery cell having a cell housing and a cell chemical system arranged in a cell housing, wherein the battery cell unit has a first functional layer which is at least partially compressible in the first direction and is arranged fixedly with respect to the battery cell, wherein the first functional layer can comprise a plurality of sub-layers which are arranged next to one another in the first direction. The plurality of sub-layers comprise at least one elastically compressible swelling layer and a thermal insulation layer.

Nevertheless, efforts also continue to be made to further improve the properties of such a cell separating element.

### SUMMARY

The object of the present invention is therefore to provide a cell separating element and a battery module which make it possible to provide a cell separating element with the best possible compressible properties and fire protection properties and also to further increase safety with regard to fire protection.

A cell separating element according to the invention for arrangement between two battery cells of a cell stack is elastically compressible at least in a first direction and comprises at least one fire protection layer. The cell separating element comprises a flexible outer shell which encloses an interior space in which a fluid is located, wherein the at least one fire protection layer is arranged in the interior space and comprises an intumescent material.

The invention is based on several findings: An intumescent material as part of a cell separating element makes it possible to implement particularly good fire protection properties between battery cells. However, these positive properties can only be realized if it is also ensured that the intumescent material, when it unfolds its effect and inflates, remains in the desired position and, in particular, is not destroyed by the external heat. By positioning the fire protection layer inside the flexible outer shell, it is advantageously possible to additionally protect the fire protection layer from destruction by the flexible outer shell in the event of external heat exposure, and in addition, the fire protection layer can be specifically held in position by the outer shell when the intumescent material inflates. It cannot, so to speak, flow out, or leak out of the intermediate spaces between the cells because it is, so to speak, locked inside the flexible outer shell. In addition, the cell separating element can be provided with elastically compressible properties in a particularly simple manner by accommodating the fluid in the interior in addition to the fire protection layer. The fire protection layer itself does not necessarily have to be compressible and, in particular, does not have to be elastically compressible. This means that there are significantly more intumescent materials available for the formation of the fire protection layer, from which suitable ones can be selected. Above all, this allows the choice of an intumescent material that is even relatively incompressible and can therefore ensure a certain distance between the walls of the flexible outer shell in a particularly reliable manner even under strong external compression of the cell separating element, so that a thermal bridge between the walls of the flexible outer shell can be avoided. Overall, a cell separating element can be provided that has very good elastically compressible properties and good fire protection properties and also allows the safety with regard to fire protection to be further increased by positioning the fire protection layer in the interior of the outer shell.

The fire protection layer can have an inflated and a non-inflated state. The transition from the non-inflated state, which is assumed below a certain limit temperature, to the inflated state at or above the limit temperature can be irreversible. The volume of the fire protection layer in the inflated state can be many times greater than the volume in the non-inflated state.

The cell separating element can have only one fire protection layer or multiple fire protection layers. The descriptions provided with reference to at least one fire protection layer may apply analogously to one or more additional fire protection layers.

In an advantageous embodiment of the invention, the outer shell is made of a metallic material, in particular steel or stainless steel. This means that the outer shell itself is very temperature-resistant and can very well ensure the protection of the fire protection layer in the interior even in the event of a thermal runaway of the adjacent battery cell. Thus, even in the case of very strong external temperature influences, the stable outer shell keeps the intumescent material in its intended effective position. In addition, the intumescent material or the fire protection layer in general is particularly well protected against external temperature and other influences such as fire.

According to a further advantageous embodiment of the invention, the fire protection layer in the interior extends in a second direction and/or third direction perpendicular to the first direction over a large part of the interior, in particular substantially the entire interior space. This applies in particular also when the fire protection layer is not inflated. When the cell separating element is arranged as intended in the cell stack, the first direction preferably corresponds to a stacking direction. The second and third directions mentioned can be defined perpendicular to this. The second and third directions can also be perpendicular to each other. Since the fire protection layer extends in the second and/or third direction over a large part of the interior, in particular essentially over the entire interior in this second and/or third direction, the protective effect of the fire protection layer can unfold over a large area. In particular, this design allows contact between the two walls of the outer shell opposite each other in the first direction to be reliably prevented by the fire protection layer located between them. Such contact would lead to a thermal bridge between the two walls, especially in the case of outer shell designs made of a metallic material, whereby heat could spread much more quickly between the battery cells in the event of thermal runaway of one of the battery cells, which in turn would impair the effectiveness of the fire protection layer. The fact that the fire protection layer extends substantially over the entire interior space in the second and/or third direction can be understood to mean that it extends over at least 95% of the height of the interior space in the second or third direction, preferably over at least 98% or even the entire interior space.

On the other hand, it is preferred, at least in the non-inflated state of the fire protection layer, that the fire protection layer does not extend over the entire interior space in the first direction. There should therefore be a gap between at least one fire protection layer and at least one of the walls of the outer shell, which can be filled with the fluid. This in turn benefits the elastically compressible properties of the cell separating element. The walls of the outer shell can be designed with a sufficiently small wall thickness so that the outer shell is flexible, even if it is made of metallic material. The outer shell can be formed for example from one or more foils, for example metal foils.

According to a further advantageous embodiment of the invention, the fire protection layer consists of the intumescent material. In other words, the fire protection layer as a whole should be made of the intumescent material. This advantageously makes it possible to provide the intumescent properties over the entire surface or the entire fire protection layer.

According to a further advantageous embodiment of the invention, the outer shell has two inner sides opposite one another in the first direction, which face the interior, in particular adjoin it, wherein the at least one fire protection layer is arranged in contact with at least one of the inner sides, in particular on only one of the two inner sides or wherein a fire protection layer is arranged on each of the two inner sides.

The inner sides can be part of the outer shell walls mentioned above. The inner sides of the outer shell can therefore delimit the interior space with respect to the first direction. They can also limit the interior space in the second and/or third direction. In particular, the outer shell can be designed, for example, in a pillow-like or bag-like manner.

The at least one fire protection layer can now be arranged on one of these two inner sides or on both inner sides. If the fire protection layer is arranged on only one of the two inner sides, this has the advantage that the cell separating element can be made thinner in the first direction. The arrangement directly on one of the inner sides also makes it possible to provide support for the fire protection layer. Nevertheless, it would also be conceivable that it is placed centrally in the interior or is freely inserted in the interior and does not necessarily have to contact the inner sides or at least does not have to contact a large area or something similar.

According to a further advantageous embodiment of the invention, the at least one fire protection layer is formed as a coating of at least one of the inner sides. By designing it as a coating, the fire protection layer automatically adjoins this inner side through the coating process and can be easily and securely held in position. The fire protection layer can be provided, for example, as fire protection paint or fire protection varnish.

According to a further advantageous embodiment of the invention, the at least one fire protection layer is formed as a plate or mat arranged on at least one of the inner sides. For fastening to the inner side, the corresponding plate or mat can then be glued to the inner side or otherwise joined to it. This also allows the fire protection layer to be reliably held in position.

Furthermore, it is also conceivable that the fire protection layer is not adhered to one or both of the inner sides in the interior of the outer shell. The fire protection layer can, for example, be simply inserted in the form of a plate or mat into the interior space between the walls of the outer shell, in particular without a material connection between the fire protection layer and the outer shell. In this case, it is advantageous if the fire protection layer is designed with sufficient rigidity to prevent slipping within the interior.

According to a further advantageous embodiment, the fluid is a gas. In other words, a gas can be accommodated as the fluid in the interior of the outer shell. A gas is characterized by very good compressibility, which allows the cell separating element to be provided with very good elastically deformable properties. In addition, a gas has very good thermal insulating properties, which in turn benefits the thermal insulation between the cells, especially in the event of a thermal runaway of one of the battery cells. In addition, a gas expands when the temperature increases, and especially in the case of a thermal event, which in turn leads to an increase in pressure in the interior of the cell separating element, whereby the adjacent battery cells can in turn be kept at a distance more easily, especially in combination with the fire protection layer provided in the interior, which then inflates and further increases the insulation effect.

The gas may, for example, be air or another gas or gas mixture, for example comprising a noble gas.

According to a further advantageous embodiment of the invention, a limit temperature of a reaction start associated with the intumescent material is less than 200° C. This means that the reaction of the intumescent material, according to which the intumescent material expands due to temperature, begins or is triggered at a limit temperature below 200° C. From this limit temperature, the intumescent material begins to inflate and increase its volume accordingly, for example by at least 5 times or even by at least 10 times. If the limit temperature assigned to the material is exceeded, the material inflates until the reaction is complete, provided that the limit temperature is not exceeded again in the meantime.

It is particularly advantageous if the limit temperature is greater than 70° C., in particular greater than 80° C., and is, for example, 100° C. This enables particularly early inflation of the material in the event of thermal runaway of a battery cell, so that it can be ensured, for example, that the material is inflated before a battery cell outgasses due to its thermal runaway. This allows the intumescent material to develop its protective effect in a timely manner. If the limit temperature is also greater than 70° or 80° or is approximately 100°, it can be guaranteed that the intumescent material does not swell at normal operating temperatures of the battery cells, which usually reach up to 60 or 65° C., and thus does not impair, for example, the swelling compensation properties of the cell separating element during normal operation.

According to a further very advantageous embodiment of the invention, the intumescent material is a silicate-based intumescent material. The material therefore contains a silicate. Additionally, the material can also be water-based. In contrast to a phosphorus-based material, for example, this has the advantage that its swelling reaction begins at 100° C. and therefore very early. In addition, a silicate-based material has the great advantage that it allows a very high inflation pressure to be achieved. In addition, such a material becomes relatively hard after inflation, in particular significantly harder than a phosphorus-based intumescent material, which makes it easier to ensure that the two walls of the outer shell can be kept at a distance by the intumescent material in between.

Nevertheless, a phosphorus-based material could also be used as an intumescent material. The fire protection layer can also comprise or consist of multiple different intumescent materials.

Furthermore, the invention also relates to a battery module having a cell stack and at least one cell separating element according to the invention or one of its embodiments.

The cell stack can comprise a plurality of battery cells arranged next to one another in a stacking direction. If the cell separating element is located between two battery cells of the cell stack, the first direction corresponds to the stack direction. A cell separating element according to the invention or a cell separating element according to an exemplary embodiment of the invention can be arranged between each two battery cells of the cell stack arranged adjacent to one another.

The battery cells can be designed, for example, as pouch cells or prismatic cells. The battery cells can in particular be formed as lithium-ion cells, for example.

Furthermore, the invention also relates to a battery having a battery module according to the invention or one of its embodiments. The battery can be designed, for example, as a high-voltage battery. In particular, this can be a traction battery for a motor vehicle.

Furthermore the invention also relates to a motor vehicle having a battery according to the invention or one of its embodiments.

The motor vehicle according to the invention is preferably designed as an automobile, in particular as a passenger car or truck, or as a passenger bus or motorcycle.

The invention also includes further developments of the battery module according to the invention and the motor vehicle according to the invention, which have features as already described in connection with the further developments of the cell separating element according to the invention. For this reason, the corresponding developments of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic and perspective cross-sectional representation of a cell separating element according to an exemplary embodiment of the invention;

FIG. 2 shows a schematic illustration of a wall of the cell separating as viewed on the inner side according to an exemplary embodiment of the invention.

FIG. 3 shows a schematic representation of a battery module with two battery cells and a cell separating element arranged therebetween at the beginning of a thermal runaway of one of the battery cells according to an exemplary embodiment of the invention;

FIG. 4 shows a schematic representation of the battery module from FIG. 3 after further advanced thermal runaway of the battery cell and with the inflated fire protection layer of the cell separating element according to an exemplary embodiment of the invention; and

FIG. 5 shows a schematic representation of a battery module with a cell separating element according to an example not belonging to the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

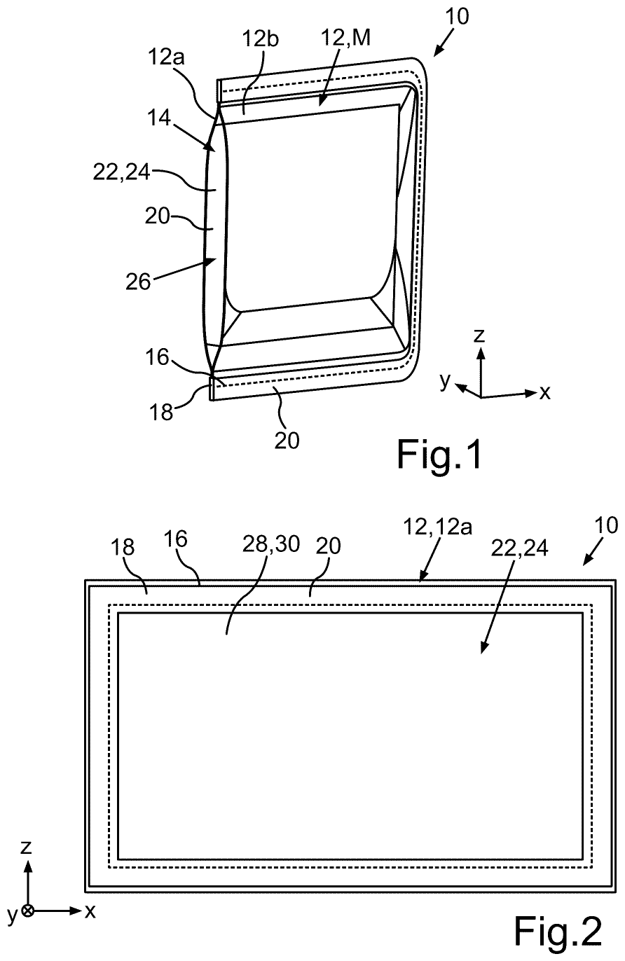

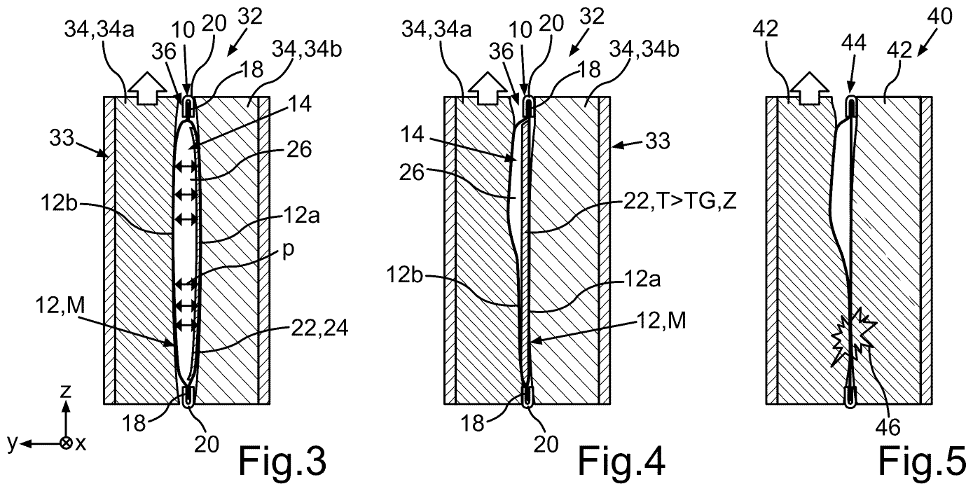

FIG. 1 shows a schematic and perspective cross-sectional representation of a cell separating element 10 according to an exemplary embodiment of the invention. The cell separating element 10 comprises a flexible outer shell 12, preferably made of a metallic material M, which encloses an interior space 14. The outer shell 12 comprises two walls 12a, 12b, which are opposite each other with respect to the illustrated y-direction, which was previously also referred to as the first direction. The walls 12a, 12b can be provided, for example, by two metal foils. At the edge, the two walls 12a, 12b can be joined together by means of a joining connection 16, for example welded together and/or connected to each other via a flanged connection or the like. The edge region 18 of the cell separating element 10 is also enclosed by a frame 20, which can also be part of the cell separating element 10, in order to stabilize the joining connection 16 in the edge region 18. The two walls 12a, 12b each have an inner side 20. The inner sides 20 of these walls 12a, 12b face each other and delimit the interior space 14. In the present case, a fire protection layer 22 made of an intumescent material 24 is arranged on one of the two inner walls 20. The intumescent material 24 or the fire protection layer 22 as a whole can be provided, for example, in the form of a fire protection paint or a fire protection varnish. The inner wall 20 can therefore be coated with this fire protection layer 22. However, it is also conceivable to provide the fire protection layer 22 in the form of a plate or a mat arranged on the inner wall 20. Due to the intumescent material 24, the fire protection layer 22 has the property of inflating above a certain limit temperature, which may be, for example, between 100° C. and 200° C., in particular between 120° C. and 200° C. In the non-inflated state below this limit temperature, the fire protection layer 22 has a very small layer thickness, for example of approximately 0.1 mm. It is also conceivable that both inner sides 20 of the walls 12a, 12b are provided with such a fire protection layer 22. However, a fire protection layer 22 is sufficient. The remaining interior space 14 of the cell separating element 10 can, however, be filled with a fluid, in particular a gas 26. Due to the thin-walled design of the walls 12a, 12b and the compressibility of the gas 26, the cell separating element 10 is designed to be elastically compressible with respect to the y-direction. Thus, the cell separating element 10 has very good elastically compressible properties on the one hand and good fire protection properties on the other. Since the fire protection layer 22 is also enclosed in the interior 14 of the outer shell 12, the fire protection layer 22 is held in position even when inflated and does not leave the space 36 between the battery cells 34 when positioned as intended in a cell stack 33 (see FIG. 3), as explained in more detail later.

FIG. 2 shows a schematic representation of a wall 12a of the outer shell 12 of the cell separating element 10, for example from FIG. 1, in a plan view of its inner side 20. The inner side 20 can be divided into a circumferential edge region 18 and a central region 28. The joining connection 16 is located in the edge region 18 when this wall 12a is joined to the opposite wall 12b of the outer shell 12. This joining connection 16 is shown schematically in the present case by a closed circumferential line. The fire protection layer 22 is located in the central region 28. This extends in the x and/or z direction over a large part of the surface 30 adjacent to the interior space 14, which defines the central region 28 of the wall 12a or its inner side 20. The fire protection layer 22 can also completely cover this central region 28.

FIG. 3 shows a schematic representation of a battery module 32 which comprises a cell stack 33 with a plurality of battery cells, and in this case, by way of example, two battery cells 34 arranged next to one another in a stacking direction y. In a space 36 between these two battery cells 34 there is a cell separating element 10 according to an exemplary embodiment of the invention. This can be configured as described above. One of the battery cells 34a is shown at the beginning of a thermal runaway. In addition to the fire protection layer 22, the fluid 26, in particular gas 26, which causes a gas pressure p, is also present in the interior space 14. This counteracts the swelling of the battery cells 34 during cell swelling with a certain counterpressure.

In the event of thermal runaway of the battery cell 34a, it may have a temperature of approximately 800° C. This leads to heating of the cell separating element 10 and correspondingly to inflation of the fire protection layer 22, as shown schematically in FIG. 4.

The fire protection layer 22 in the illustration according to FIG. 4 therefore has a temperature T which is greater than or at least equal to its limit temperature TG, starting from which the expansion reaction of the fire protection layer 22 is triggered. As a result, the volume of the fire protection layer 22 increases many times over, for example at least 5 times or even 10 times. Due to the thermal runaway of the battery cell 34a, a strong deformation of this battery cell 34a can occur and, accordingly, an uneven and very strong pressurization of the cell separating element 10. By means of the fire protection layer 22 located in the interior 14, which is then in an inflated state Z, a direct contact between the inner sides 20 of the walls 12a, 12b of the cell separating element 10 in the central region 28 and thus a thermal bridge can be prevented. Thus, the neighboring cell 34b is very well protected from the thermally runaway battery cell 34a. This ensures that the battery cells 34a, 34b remain safely thermally insulated from each other. In other words, even in the event of a thermal runaway of a battery cell 34a, the two cells 34 do not come into thermal contact with each other.

FIG. 5 shows a schematic representation of a battery module 40 according to an example not belonging to the invention. In particular, there is a cell separating element 44 without a fire protection layer 22 between two battery cells 42. As can be seen, in the event of a thermal runaway of one of the two battery cells 22, the walls of this cell separating element 44 come into contact with each other, at least locally. This creates a thermal short circuit 46 between the cells 42. This can advantageously be prevented by a cell separating element according to the invention or one of its embodiments.

Overall, the examples show how the invention can provide an insulation element, namely the cell separating element, as a foil bag plus fire protection coating. Since a thermally runaway battery cell often loses a lot of volume and thus its integrity during a thermal runaway, a foil bag without a fire protection layer would swell into the empty region and a thermal short circuit would occur in the remaining regions. This would negatively affect the insulation function of this component. This can be prevented according to the invention, in particular by applying an intumescent varnish or, in general, an intumescent fire protection layer to one or both film halves within the film pocket provided by the outer shell. This swells when exposed to heat. This can prevent a thermal short circuit in the system regions. A thin layer thickness in the non-inflated state ensures a small block size and continues to absorb swelling forces. This also enables cost-effective implementation through mass production.

1. A cell separating element for arrangement between two battery cells of a cell stack, wherein the cell separating element is elastically compressible at least in a first direction and comprises at least one fire protection layer,
wherein the cell separating element comprises a flexible outer shell enclosing an interior space in which a fluid is located, wherein the at least one fire protection layer is arranged in the interior space and comprises an intumescent material.

2. The cell separating element according to claim 1, wherein the outer shell is made of a metallic material, in particular steel or stainless steel.

3. The cell separating element according to claim 1, wherein the fire protection layer extends in the interior in a second direction and/or third direction perpendicular to the first direction over a large part of the interior space, in particular substantially the entire interior space.

4. The cell separating element according to claim 1, wherein the fire protection layer consists of the intumescent material.

5. The cell separating element according to claim 1, wherein the outer shell has two inner sides opposite one another in the first direction, which face the interior space, in particular adjoin it, wherein the at least one fire protection layer is arranged in contact with at least one of the inner sides, in particular on only one of the two inner sides.

6. The cell separating element according to claim 1, wherein the at least one fire protection layer
is designed as a coating of at least one of the inner sides, or
is designed as a plate or mat arranged on at least one of the inner sides.

7. The cell separating element according to claim 1, wherein the fluid is a gas.

8. The cell separating element according to claim 1, wherein a limit temperature of a reaction start associated with the intumescent material is less than 200° C.

9. The cell separating element according to claim 1, wherein the intumescent material is a silicate-based intumescent material.

10. A battery module with a cell stack and at least one cell separating element according to claim 1.

11. The cell separating element according to claim 2, wherein the fire protection layer extends in the interior in a second direction and/or third direction perpendicular to the first direction over a large part of the interior space, in particular substantially the entire interior space.

12. The cell separating element according to claim 2, wherein the fire protection layer consists of the intumescent material.

13. The cell separating element according to claim 3, wherein the fire protection layer consists of the intumescent material.

14. The cell separating element according to claim 2, wherein the outer shell has two inner sides opposite one another in the first direction, which face the interior space, in particular adjoin it, wherein the at least one fire protection layer is arranged in contact with at least one of the inner sides, in particular on only one of the two inner sides.

15. The cell separating element according to claim 3, wherein the outer shell has two inner sides opposite one another in the first direction, which face the interior space, in particular adjoin it, wherein the at least one fire protection layer is arranged in contact with at least one of the inner sides, in particular on only one of the two inner sides.

16. The cell separating element according to claim 4, wherein the outer shell has two inner sides opposite one another in the first direction, which face the interior space, in particular adjoin it, wherein the at least one fire protection layer is arranged in contact with at least one of the inner sides, in particular on only one of the two inner sides.

17. The cell separating element according to claim 2, wherein the at least one fire protection layer
is designed as a coating of at least one of the inner sides, or
is designed as a plate or mat arranged on at least one of the inner sides.

18. The cell separating element according to claim 3, wherein the at least one fire protection layer
is designed as a coating of at least one of the inner sides, or
is designed as a plate or mat arranged on at least one of the inner sides.

19. The cell separating element according to claim 4, wherein the at least one fire protection layer
is designed as a coating of at least one of the inner sides, or
is designed as a plate or mat arranged on at least one of the inner sides.

20. The cell separating element according to claim 5, wherein the at least one fire protection layer
is designed as a coating of at least one of the inner sides, or
is designed as a plate or mat arranged on at least one of the inner sides.
